(19) United States
(12) Patent Application Publication
(10) Pub. No.: US 2019/0114325 A1
(43) Pub. Date: Apr. 18, 2019

(54) METHOD OF FACET-BASED SEARCHING OF DATABASES

(71) Applicant: UNITED ARAB EMIRATES UNIVERSITY, AL AIN (AE)

(72) Inventors: NAZAR ZAKI, AL AIN (AE); CHANDANA TENNAKOON, AL AIN (AE)

(21) Appl. No.: 15/709,312

(22) Filed: Oct. 13, 2017

(51) Int. Cl. G06F 17/30

(52) U.S. Cl. CPC G06F 17/3053; G06F 17/30867; G06F 17/30554

(57) ABSTRACT

The method of facet-based searching of databases uses a facet ranking scheme for the searching and information retrieval from large scale, semantic databases, such as semantic biological databases. The method of facet-based searching of databases includes a ranking scheme for facet values to order them by their significance to a search query. The method of facet-based searching of databases also includes a subsequent scheme to present the user with a narrowed set of facet values when a large number of choices are available. In biological databases, for example, users are typically interested in finding average or extreme values. Thus, the user is able to narrow the set of facet values to values that are average, most common, least common and/or most/least significant in a search result. Additionally, the facets themselves can be ordered according to their usefulness in narrowing down the search.

### BACKGROUND

### 1. Field

The disclosure of the present patent application relates to searching and information retrieval from databases, and particularly to a method of facet-based searching of databases utilizing ranking of facet values.

### 2. Description of the Related Art

Large scale databases, such as biological databases, are constantly growing in both volume and number. Such databases are maintained in a variety of diverse formats. The Resource Description Framework (RDF) was developed for semantic web applications, providing for the storage and connection of these heterogeneous sources of data. Briefly, the RDF is a family of World Wide Web Consortium (W3C) specifications, originally designed as a metadata data model. It has since come to be used as a general method for conceptual description or modeling of information that is implemented in web resources, using a variety of syntax notations and data serialization formats. It is also used in knowledge management applications. Exploring the connected semantic web databases is an important problem. Although there are many effective search engines for exact searches, exploratory search engines are still not well developed.

In addition to the difficulties associated with exploratory searching of such large scale and interconnected databases, the number of users accessing search engines with mobile devices is constantly increasing, with an expectation that this number of users will surpass desktop users within the next few years. Mobile device users face restrictions when compared to desktop users in terms of screen space and quotas for data transmission. These users require their search results to be displayed in a manner that uses the screen display area optimally while also transferring the least amount of data possible. It would obviously be desirable to have a search engine that is both mobile device friendly, as well as addresses the exploratory search needs for RDF databases.

Facets are a popular method of exploring databases. Faceted searching, also referred to as faceted navigation or faceted browsing, is a technique for accessing information organized according to a faceted classification system, allowing users to explore a collection of information by applying multiple filters. A faceted classification system classifies each information element along multiple explicit dimensions, called facets, enabling the classifications to be accessed and ordered in multiple ways rather than in a single, pre-determined, taxonomic order. Facets correspond to properties of the information elements. They are often derived by analysis of the text of an item using entity extraction techniques or from pre-existing fields in a database such as author, descriptor, language, and format. Thus, existing web-pages, product descriptions or online collections of articles can be augmented with navigational facets.

The faceted classification is a classification scheme used in organizing knowledge into a systematic order. A faceted classification uses semantic categories, either general or subject-specific, that are combined to create the full classification entry. Many library classification systems use a combination of a fixed, enumerative taxonomy of concepts with subordinate facets that further refine the topic.

A faceted classification system uses a set of semantically cohesive categories that are combined as needed to create an expression of a concept. In this way, the faceted classification is not limited to already defined concepts. While this makes the classification quite flexible, it also makes the resulting expression of topics complex. To the extent possible, facets represent clearly defined, mutually exclusive and collectively exhaustive aspects, properties or characteristics of a class or specific subject. Some commonly used general-purpose facets are time, place and form. Search in systems with faceted classification can enable a user to navigate information along multiple paths corresponding to different orderings of the facets. This contrasts with traditional taxonomies in which the hierarchy of categories is fixed and unchanging. It is also possible to use facets to filter search results to more quickly find desired results.

Facets contain attributes and each facet contains a set of values an attribute can take. In some databases, there can be many facets and each facet might contain a large number of values. Under such circumstances, a user performing exploratory searches on a database may be overwhelmed by the available choices of facets and their values. This is a particular concern for mobile device users, since a large number of facets and facet values will incur higher data transfer costs. Further, the screen space limits the number of choices that can be perceived by the user. It would be desirable to be able to show the user only the most relevant facets and facet values.

Faceted exploration can present difficulties, particularly when the number of facets is large or when the number of facet values in a facet is large. In the first case, the user is typically not quite sure which facets to explore. The latter case presents a similar problem, and presenting the choices for facet values in a reasonable way (e.g., a select box or a set of check boxes) might prove to be difficult. For example, a biological database might provide thousands of genes as possible facet values. These problems become more significant when the available display area is limited, such as on a typical smartphone. Thus, it is important to provide techniques which present users with facets and facet values in a way that will not overwhelm them and guide them to quickly narrow down the entries in a database that suits the users' requirements.

There are numerous methods used for ranking facets and facet values. One popular technique is the frequency or count-based ranking technique, where higher prominence is assigned to facets or facet values with higher occurrence rates. Another common method is set-cover ranking, where the goal is to find a set of categories that maximizes (or covers) the number of distinct objects found under them. In merit-based ranking, a cost is associated with discovering an item of interest. The cost is calculated based on factors such as the cost of finding the item, the cost of selecting a correct search path and the cost of correcting a wrong path.

A further common approach involves treating a search as a decision tree building process, where each node is an attribute and edges are the values of the attribute. A ranking in this case is assigned based on the expected number of searches needed to reach an item of interest. There are also ranking methods that measure mutual information of the likelihood of a facet value associated with a document and the probability of a document being relevant. Other techniques use various “interestingness” functions to rank facets, where the concept of interestingness is defined as how surprising an aggregated value is based on a given expectation. Most of these methods can be performed using graph based techniques and, theoretically, RDF can fit naturally into such a framework. However, for large databases, such as biological databases, the processing time can be excessive.

There are several common techniques used to address the problem of presenting a large number of facet values. When numerical facet values (e.g., prices) are involved, a slider can be presented to set the range of values allowed for facet values. The range of facet values can also be broken down into ranges of values or “buckets”. Another common approach uses the frequency of a facet value in the database restricted by the query. The facet values can then be sorted in ascending or descending order according to this frequency. This brings some order to the facet values, and sometimes the user is only presented with a fixed number of high or low frequency facet values. Ordering of facets and facet values can also be performed based on analyzing user responses. Each of these techniques, though, has drawbacks. When a slider is presented, for example, users cannot identify the distribution of the values, and only the range of possible values is given. One or two outliers can give a skewed picture of the facet values. The same problem applies to the bucketed display of facet values. As an example, if the user is looking at expression levels of genes, just showing the range of expression will not give the user an idea about what the normal expression range and the low and high expression ranges are.

The sorting of facet values by frequency alone may not provide the user with the actual information the user seeks. A frequency calculation based on current query does not provide the user with information about the frequency of the item with relation to the entire database. An item with a high frequency across the database will turn up as having a high frequency in an arbitrary query only by chance. A user interested in facet values specific to the current query will not find this raw frequency information very useful. As an example, a biological database may contain variations in human genomic data. The population samples in the exemplary database might have a high representation of samples from certain regions of the world due to logistic reasons (e.g., most samples might originate from regions like the United States and Europe, where there are large sequencing centers). As such, certain variations will be either over or under represented according to their presence in major population groups in the database. If a researcher bases judgment purely on the raw frequency of a variation, a wrong conclusion can be easily reached. What the user requires in this case is a measure of the frequency of the variations in the query relative to their frequencies in the database.

Capping off of facet values has the disadvantage of limiting knowledge about the facet values. The user cannot get the full picture of the range of the facet values. Ordering of facets and facet values based on user behavior is a good option when there is a sufficiently large user base and user behavior is relatively homogeneous. However, there may be users searching in niche areas and a large amount of heterogeneity in the searches. In such cases, presenting all users with values tailored for a general audience might not be useful. Thus, a method of facet-based searching of databases solving the aforementioned problems is desired.

### SUMMARY

The method of facet-based searching of databases uses a facet ranking scheme for the searching and information retrieval from large scale, semantic databases, such as semantic biological databases. The method of facet-based searching of databases includes a ranking scheme for facet values to order them by their significance to a search query. The method of facet-based searching of databases also includes a subsequent scheme to present the user with a narrowed set of facet values when a large number of choices are available. In biological databases, for example, users are typically interested in finding average or extreme values. Thus, the user is able to narrow the set of facet values to values that are average, most common, least common and/or most/least significant in a search result. Additionally, the facets themselves can be ordered according to their usefulness in narrowing down the search.

The method of facet-based searching of databases may be implemented using the SPARQL Protocol and RDF Query Language (SPARQL), a semantic query language for databases which is able to retrieve and manipulate data stored in Resource Description Framework (RDF) format. The method of facet-based searching of databases provides a faceted search engine for RDF databases which can make best use of screen space and avoid unnecessary data transfers between the database and the client. In the method of facet-based searching of databases, the user is presented with the most relevant facets for exploration with high priority, along with an indication of how many facet values each facet has. The amount of prioritized facets displayed can be based on the screen display area. Instead of sending all possible facet values, only a subset of facet values can be passed to the client to save data charges. This allows the method to quickly produce subsets of facet values the user has interests in, as well as providing continuous feedback on the facet values related and relevant to the search results.

In the method of facet-based searching of databases, search results are initially received from the RDF database. A context dependent facet set is then applied to the search results, where the context dependent facet set includes a facet value for each of a plurality of facets associated with the search results, and a facet value count, where the facet value count is a count of the search results to which the facet value applies. The user then receives a list of the facets and the facet value counts, where the list of the facets and the facet value counts is ordered according to a selected ranking of facets. The user inputs a selection of at least one facet from the list of the facets and the facet value counts, the search results are filtered based on this selection. At least a subset of the search results is displayed to the user based on the selection of the at least one facet, where the subset of the filtered search results is based on a user-selected parameter. The user-selected parameter may be, for example, frequency of the facet values in the search results, with the user being able to select average or extreme search results (i.e., most common or least common) based on the calculated frequencies. Alternatively, the user-selected parameter may be a significance score, which is based on a probability of the facet values in the search results not appearing by chance. The user may select a display of search results based on greatest significance scores (i.e., most significant, as it is less likely to appear by chance) or least significance scores (i.e., least significant, as it is more likely to appear by chance).

If the user does not elect to explore using the significance values for the search, the facet values will be color coded to show their distance to the average. These choices can be presented to the user in a context menu. After the choice has been made, a SPARQL query to generate the corresponding facet values will be sent to the database. If the user wishes to see more or less facet values under the current facet, the user makes another request and the database server updates the facet values.

These and other features of the present disclosure will become readily apparent upon further review of the following specification and drawings.

### BRIEF DESCRIPTION OF THE DRAWINGS

FIG. 1 is a block diagram illustrating a system for implementing a method of facet-based searching of databases.

FIG. 2 is a graph showing results of a percentage of transferred data volume saved when using the method of facet-based searching of databases with extreme value filtering compared against a control search engine using conventional frequency-based filtering.

FIG. 3 is a graph showing results of a percentage of transferred data volume saved when using the method of facet-based searching of databases with average value filtering compared against the control search engine using conventional frequency-based filtering.

FIG. 4 is a graph showing results of a percentage of transferred data volume saved when using the method of facet-based searching of databases with significance filtering compared against the control search engine using conventional frequency-based filtering.

FIG. 5 is a graph showing results of a percentage of transferred data volume saved when using the method of facet-based searching of databases with significance filtering compared against the control search engine using conventional frequency-based filtering.

FIG. 6 is a graph comparing a number of facet values produced using the method of facet-based searching of databases with extreme value filtering compared against a control search engine without filtering.

FIG. 7 is a graph comparing the number of facet values produced using the method of facet-based searching of databases with average value filtering compared against the control search engine without filtering.

FIG. 8 is a graph comparing the number of facet values produced using the method of facet-based searching of databases with significance filtering compared against the control search engine without filtering.

Similar reference characters denote corresponding features consistently throughout the attached drawings.

### DETAILED DESCRIPTION OF THE PREFERRED EMBODIMENTS

The method of facet-based searching of databases uses a facet ranking scheme for the searching and information retrieval from large scale, semantic databases, such as semantic biological databases. The method of facet-based searching of databases includes a ranking scheme for facet values to order them by their significance to a search query. The method of facet-based searching of databases also includes a subsequent scheme to present the user with a narrowed set of facet values when a large number of choices are available. In biological databases, for example, users are typically interested in finding average or extreme values. Thus, the user is able to narrow the set of facet values to values that are average, most common, least common and/or most/least significant in a search result. Additionally, the facets themselves can be ordered according to their usefulness in narrowing down the search.

The method of facet-based searching of databases may be implemented using the SPARQL Protocol Query Language (SPARQL) on a Resource Description Framework (RDF) database. SPARQL is a semantic query language for databases which is able to retrieve and manipulate data stored in RDF format. Semantic databases can include triplets specifying relations in the form of subject, predicate and object. This provides a natural way to generate facets out of predicates and facet values out of objects. The predicates, objects and their counts can be found easily with SPARQL queries.

Facets are a type of taxonomy where attributes and values are classified. Values for a given attribute are displayed as children of that attribute. The attributes are called facets and the values are called facet values. The method of facet-based searching of databases provides a faceted search engine for RDF databases which can make best use of screen space, e.g., for mobile devices, and avoid unnecessary data transfers between the database and the client. In the method of facet-based searching of databases, the user is presented with the most relevant facets for exploration with high priority, along with an indication of how many facet values each facet has. The amount of prioritized facets displayed can be based on the screen display area. Instead of sending all possible facet values, only a subset of facet values can be passed to the client to save data charges. This allows the method to quickly produce subsets of facet values the user has interests in, as well as providing continuous feedback on the facet values related and relevant to the search results.

In the method of facet-based searching of databases, facet values are classified either using their frequency distribution or by their values themselves, with values being categorized as either common values or un-common (extreme) values. This categorization may be presented to the user using either a visual color scheme or by allowing the user to select which range of values are needed. Further, the method of facet-based searching of databases measures the probability of a facet value appearing only by chance on a facet. A lower value of this probability indicates that a facet value is more significant to the current search compared to a facet value with a higher probability.

As noted above, an RDF database consists of subject, predicate and object triplets. A triplet describes a subject having a property (predicate) given by the object. The goal of the method of facet-based searching of databases is to retrieve the set of subjects S matching a given search criteria. The facets are the predicates for subjects in S. The values of a facet are the distinct objects connected to a subject in S via the predicate corresponding to the facet. In use, the user inputs a query via a conventional interface, such as a keyboard, smartphone touchscreen or the like. This query is converted to an equivalent SPARQL query and the RDF database is interrogated with the SPARQL query. The search results and facet information for the query are sent by the database server to the user interface, and the interface is updated to reflect new facets and search results.

Unless the number of facets is relatively small, it is typically not advisable to provide the user with all of the available facets. It is more desirable if the facets can be prioritized in some way and the user provided with important facets that can guide his or her search most efficiently. For each database, certain facets can be identified that are important and, similarly, those that are not very important can also be identified. For example, in the Universal Protein resource (UniProt) database, the protein names are important and in a sequencing library database, lane numbers and other information related to a particular run are generally unimportant. These unimportant facets may be marked at the time of constructing the databases, and they will not be generated unless the user explicitly asks to do so. The important facets are selected according to how they help narrow down the search space and the user only receives the number of facets required to update his or her display.

The facet generation process is performed as follows: First, based on the search result, a list of available facets, including a count of distinct facet values for each facet, is generated. These facets and facet counts are then displayed to the user. The user next selects a facet and chooses to see all entries or a subset of entries. For example, if a facet contains a list of genes, the user may wish to see all of the genes that are over-represented. Depending on this selection, a request is made to the database and the database returns the relevant facet values to the client. These facet values are then displayed.

In the above, in the initial step, only a list of facets and facet value counts is generated, rather than the list of facets and all their facet values. In other words, rather than listing all facets and their facet values, the facets and only the count of facet values are generated. The reason for this is that only a small number of the facets will be used by a user during a session and it will be wasteful to transfer data for unused facets. The count is displayed to inform the user about the amount of available facet values. The facets are displayed in the prioritized order selected by the user. It should be noted that only the amount of information needed to refresh the screen is transferred between the device and the database.

At this point, the user may select to explore the database using a facet. If the number of choices are relatively small, the user can view all of the available choices. On the other hand, when there is a relatively large number of choices, users may prefer to select only the extreme or average values. One other possibility is the user electing to see only the significant values. If the user does not elect to explore using the significance values for the search, the facet values will be color coded to show their distance to the average. These choices can be presented to the user in a context menu. After the choice has been made, a SPARQL query to generate the corresponding facet values will be sent to the database. If the user wishes to see more or less facet values under the current facet, the user makes another request and the database server updates the facet values.

The database needs to be supplemented to help the faceted search. Some global statistics are required to generate the rankings of a facet value Fᵢ. The first statistic, cᵢ, is the number of times Fᵢ occurs in the database, and the second statistic, cᵢ′, is the number of times the facet value Fᵢ occurs in the search result. cᵢ is a constant for a fixed database and can be pre-calculated. cᵢ′, can be efficiently calculated along with the facet values and facets using a conventional query. For example, in SPARQL, the query would be:

SELECT (fn:concat(?facet,’---‘,?facetpred) AS ?facetname)(COUNT
(?subject) AS ?total)
{

?subject ?facetpred ?facet .

}
GROUPBY ?facet ?facetpred

While cᵢ can also be calculated on the fly, it will be time consuming when there are a large number of facet values. Therefore, the database is pre-processed and cᵢ is stored for each facet value Fᵢ. These counts themselves are stored in the RDF database as triples in the form (Fᵢ, DATABASE:Count, cᵢ), where DATABASE:Count is a reserved resource.

Although there are many predicates associated with subjects in a database, not all of them are relevant to searches. For example, in sequencing experiments, data such as platforms, experiment dates and lane number are generally irrelevant. Such predicates can be marked as hidden facets, where no processing is performed on them unless the user specifically requests to activate them. There are some other facets that do not make sense if shown by themselves. For example, a location in a genome is usually represented by two separate entries of chromosome and co-ordinate. While showing the chromosome as a facet may be of use, just showing the co-ordinate as a facet will provide the user with a list of numbers without any context. Such dependent facet values should be indicated and their dependency stored as an entry in the RDF database. Further, the database is pre-processed so that if predicate P₁ depends on the predicate P₂, then Pᵢ is added as a prefix of P₂; i.e., in the example of the chromosome and the location, all locations are added to the corresponding chromosomes as a prefix.

If a database contains N distinct facet values for a given facet, n₁, . . . , n_{N}, then there are c₁, . . . , c_{N} entries in each category, respectively. There are also c₁′, . . . , c_{N}′ entries, respectively, in each category after a query. In cases where the user might want to know some property that has the highest/lowest representation, the results are typically ranked by the descending/ascending order of their frequency c₁, c₂, . . . , c_{N}. With regard to ranking, frequency counts can be misleading since, if a facet value is over-represented in a database, then it may appear with a high frequency in a facet simply by chance. In many contexts, it is better to have an idea about the importance of each facet value to the search result. One solution to this problem is to find the probability of a facet value appearing by chance in any query. If this probability is low, then the facet value has a high significance for the current query.

For a facet value nᵢ, an entry in this category would be selected with a probability pᵢ given by

$${p}_{i} = \frac{{n}_{i}}{{\sum }_{j = 1}^{N} {n}_{j}} .$$

The probability of selecting nᵢ′ elements from the category nᵢ, αᵢ, is calculated as αᵢ=P(X=nᵢ′|Bin(Σⱼ₌₁^{N}nⱼ′,pᵢ)). A lower value of αᵢ indicates that category nᵢ appears with a higher or lower probability than expected. These categories can be ranked by ascending order of αᵢ. Similarly, facet values can be ranked according to their over- or under-representation. βᵢ=P(X>nᵢ′|Bin(Σⱼ₌₁^{N}nⱼ′,pᵢ)) and γᵢ=P(X<nᵢ′|Bin(Σⱼ₌₁^{N}nⱼ′,pᵢ)) respectively represent the probabilities that the category nᵢ is over- or under-represented in the query. αᵢ, βᵢ and γᵢ are referred to hereafter as “significance scores”.

With regard to filtering of important facet values, a set of important facet values can be retained when presented with a large number of options. Two separate filtering techniques will be described below: first, a technique using facet values ranked by frequency or when the facet values are numeric, and another technique in which the facet values are ranked by significance. As an example of facet value filtering, in biological databases the users are mostly interested in extreme and average value cases. For example, the researchers may look for common variants or rare variants in a population. They might also look for genes having average, high or low expression in various tissues.

When significance ranking is used, the ranking is based on probabilities. Users in this case are interested in most significant facet values to a query. How likely one facet value is to appear by chance can be compared against another facet value. Informally, such comparisons of probabilities are made by statements such as “the probability of X happening is ten times less than the probability of Y happening.” This statement can be formally translated into a significance ranking as follows: If the top significance is P_{M}, then only those facet values with a probability smaller than λP_{M}, for some positive A, are reported. This will reject all the facet values with a probability exceeding the best facet value by A times or more. By changing the value of λ, the most significant facet values can be zoomed in and out. For example, if λ=10, the system will only retain facet values whose significance does not drop ten times below the most significant facet value.

When facet values are ranked by their frequency, the mean μ and standard deviation σ conveys information about the average values of the frequencies and their dispersal around the average. The standard deviation can be used as a unit of measurement to check the closeness of a facet value frequency to the average. The average values can be displayed by reporting the facet values having a frequency in the interval μ±Mσ, where M is some positive number. By decreasing (increasing) M, values that are closer (further) to the average can be found. For finding values in the upper (lower) extremes, frequencies that are larger (lower) than μ+\acute{M}σ(μ−\acute{M}σ) can be filtered for some positive integer \acute{M}. By decreasing (increasing) the value of \acute{M}, the values closer (further) to the average can be zoomed in and out.

The values for M and \acute{M} can be decided based on the properties of the normal distribution. While the real distribution of the facet value frequencies need not be normal, it can be thought of as an idealized general distribution. Since more than 95% of the normal distribution is within twice the standard deviation from the mean, it is a tentative default value for finding extreme values. Taking the values where half the distribution will be found,

$${M}^{′} = \frac{2}{3} σ .$$

If we want to calculate M and \acute{M} without assuming an underlying distribution, Chebyshev's inequality can be used. For example, according to the inequality ˜75% of the data will lie within two standard deviations of the mean. Alternatively, the interquartile range can be used, followed by filtering out extreme values based on a multiple of the interquartile range.

In addition, a visual representation of the extremeness of a facet value can be given, based on the frequency f, specifically by assigning the extremeness a color with an intensity that is proportional to

$$\frac{f - μ}{σ} .$$

### If

$$\frac{f - μ}{σ} > 0 ( \frac{f - μ}{σ} < 0 ) ,$$

the facets will have a higher (lower) frequency than the average. Two distinct colors can be used to distinguish these different cases. The case where facet values are numeric can be similarly handled. Instead of facet value frequencies, the process is performed using the facet values themselves.

In some cases, there may be too many facets and the user may wish to order the facets in a way that will help himself or herself. In such a case, the set of facets may be prioritized so as to narrow down the search rapidly. Each facet contains a set of facet values, and the frequency of each facet value can be found in the search result. For example, if Facet 1 contains three facet values f₁, f₂, f₃, then selecting only the first facet value, f₁, will narrow the result to f₁ hits containing Facet 1; i.e., facet value frequencies can indicate the size of the next search result. If the facet values with the lowest frequencies are chosen, the search can be narrowed down rapidly.

In the following, for a facet Fⱼ, f(v) is the frequency of facet value v. The situations where the user is interested in average or extreme (high or low) values is considered: X_{high}^{j}=[μⱼ+\acute{M}σⱼ,∞); X_{avg}^{j}=[μⱼ+Mσⱼ, μⱼ−Mσⱼ]; and X_{low}^{j}=(−∞, μⱼ−\acute{M}σⱼ), where μⱼ and σⱼ are the mean and the standard deviations of the frequencies for facet values of Fⱼ, respectively. Further, X̅ₚ^{j}={xϵFⱼ|f(x)ϵXₚ^{j}}. For each Fⱼ, the set of average and extreme values Bⱼ=X_{high}∪X_{avg}∪X_{low} can be found. The set of facet values Fⱼ=X_{high}^{j}∪X_{avg}^{j}∪X_{low}^{j} whose frequencies are in the set Bⱼ are then found; i.e., the facet values that are extreme or average are taken. For each facet Fⱼ, a score S is then assigned as

$$S ( {F}_{j} ) = {\sum }_{v ∈ {\overline{F}}_{j}} \frac{f ( v )}{\vert {\overline{F}}_{j} \vert} .$$

This score gives the average frequency per facet value if an extreme or average value is chosen randomly. The facets having the least scores will produce the narrowest search paths on average. Therefore, facets are sorted by ascending order of these scores.

It should be noted that the above takes into account only the average frequency per facet value. However, from a practical point of view, if there are a large number of facet values presented to a user after extreme or average value filtering, such a facet will not be helpful, even if the average facet value frequency is low. For example, a facet containing five facet values having 100 entries each is more useful than a facet containing 100 facet values having one entry each. Extreme or average facet value sets with a large number of facets are ignored by setting X̅ₚ^{j}=Ø if X̅ₚ^{j}<V when calculating S(Fⱼ). V is set to be a suitable number of facet value entries that a user can comfortably process. Those facets that have F̅ⱼ=Ø will be assigned a score S(Fⱼ)=∞.

While the score S gives an idea about the number of results per facet value, the distribution of the results in each facet value may be extremely skewed. For example, consider facets A and B, each having 50 entries. Facet A has five facet values, each with ten entries; i.e., an even distribution over six facet values. However, exemplary facet B also has five facet values, but with one facet value having one entry, one facet value having four entries, one facet value having five entries, and two facet values each having twenty entries. If the user chooses the facet values containing the large number of results, he or she may be overwhelmed. When average behavior is considered, it is better to have the facet frequencies distributed as evenly as possible to avoid very large search spaces. For this purpose, entropy measurements may be used. The probability of selecting a facet value vϵFⱼ can be calculated as

$$p ( v ) = \frac{f ( v )}{{\sum }_{l ∈ {F}_{j}} f ( l )} .$$

The entropy of v is given by −p(v)log(p(v)). Thus, the total entropy of the facet Fⱼ is given by H(Fⱼ)=−Σ_{vϵF}_{ⱼ}p(v)log(p(v)). If the frequencies of the facet values are all equal, the entropy will be highest. If a single facet value has a large frequency compared to another, the entropy would be smaller. A larger value of H(Fⱼ) indicates an even distribution of facet values.

The facets can be sorted by the H and S scores as well as by the significance scores. Alternatively, a weighted score can be calculated and users given the choice to change the weights on the fly. One advantage of this method is when the screen space is limited and bandwidth needs to be preserved. The search engine can display only the highest ranked facets that are sufficient to fill or refresh the current screen area.

As noted above, the method may be implemented using SPARQL, and the SPARQL queries needed to generate facets, facet values and their ranking can be easily generated. The SPARQL query given above, for example, generates a hyphen separated facet and facet value pair, along with the count of the facet value. The result of this query is sufficient to generate each facet with corresponding facet values and frequencies. The basic SPARQL keywords like COUNT, GROUPBY and DISTINCT can be used to generate all the facets, facet values and statistics needed on the fly.

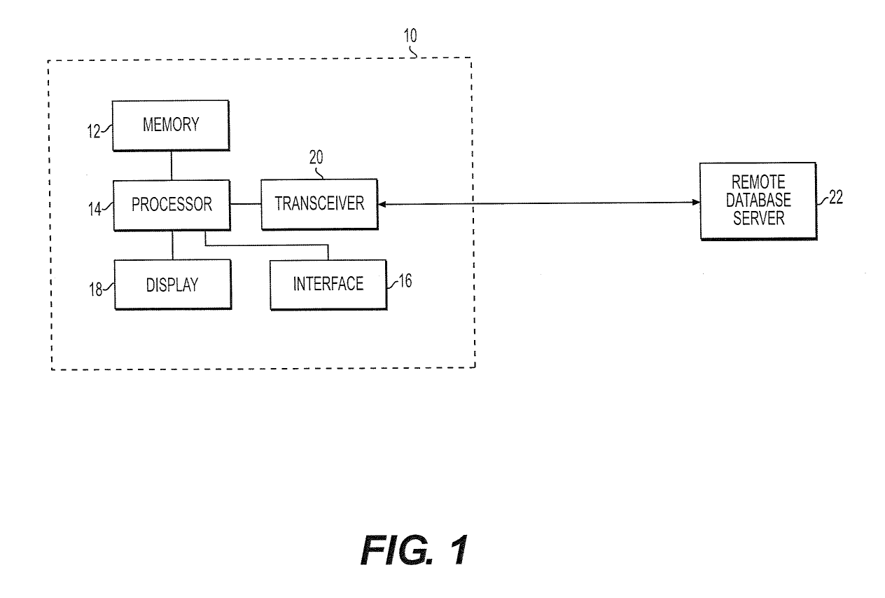

It should be understood that the calculations may be performed by any suitable computer system, such as that diagrammatically shown in FIG. 1. Data is entered into system 10 via any suitable type of user interface 16, and may be stored in memory 12, which may be any suitable type of computer readable and programmable memory and is preferably a non-transitory, computer readable storage medium. Calculations are performed by processor 14, which may be any suitable type of computer processor and may be displayed to the user on display 18, which may be any suitable type of computer display. It should be understood that interface 16 and display 18 may be provided in a single user interface, such as a touchscreen associated with a conventional smartphone or other mobile device, for example. Processor 14 is in communication with the external, remote database server 22 through any suitable type of transceiver 20, such as the onboard wireless transceiver associated with a conventional smartphone or other mobile device, for example.

Processor 14 may be associated with, or incorporated into, any suitable type of computing device, for example, a personal computer, smartphone, programmable logic controller or the like. The display 18, the processor 14, the memory 12, the interface 16, the transceiver 20 and any associated computer readable recording media are in communication with one another by any suitable type of data bus, as is well known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that may be used in addition to memory 12, or in place of memory 12, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

In order to test the method of facet-based searching of databases, a sample biological database was used. The sample RDF database contained sample data related to viral integration. The test search was performed to find out which genes are affected by the virus. The database included 114 genes total and the search was performed on a mobile device. The first stage of the test search, as described above, only produced facet names and the number of possible values under each facet. It is important to note that no facet value is transferred at this point in the search process.

In the test, the user desired to look at genes that were prominent in the data set. Thus, the user selected the choice of genes having an extreme distribution. The search only produced 11 genes falling within the parameters of the “extreme” distribution (as described above). At this point in the search, the facet values are transferred from the database server. In the test search, which resulted in 11 genes within the extreme distribution, only 14% of the total facet values were transferred to the user's mobile device from the original list. The deviation from the average, or the “extremeness” of the occurrence, was indicated by color variation on the user's screen display. Lighter colors indicated high deviations. In this particular test, the hTERT and MLL4 genes appeared as very extreme values in 28 and 16 samples, respectively, thus indicating to the user that these genes are very important.

Next, in the test, the user chose to look at samples with normal tissues. Again, the desired goal was to find out which genes are affected in the normal samples. In this case, there were 24 genes listed, which is still a relatively large number of results. To narrow down the list, the user chose to see the most significant results for the search. This resulted in only one significant gene being found. In this particular test, the sole FN1 gene turned out to be the exact gene identified as being recurrent in affecting normal samples.

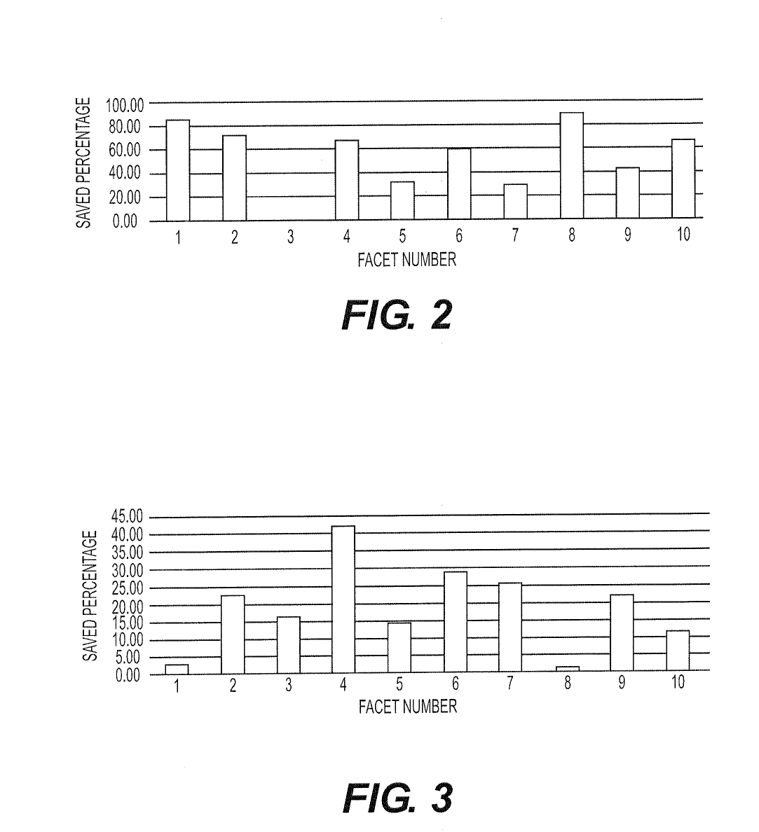

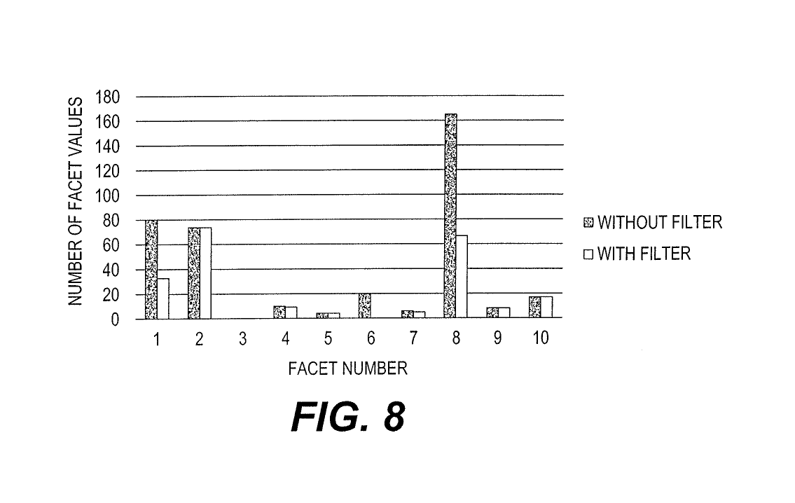

With regard to FIGS. 2-8, the amount of data transferred between the database server and the client, when facets are displayed in their default setting, was compared against the amount of data transferred when filtering by the method of facet-based searching of databases is used. Here, the default setting is assumed to be the display of facets with their frequency information. FIG. 2 shows the percentage of data volume saved when a facet is filtered by extreme value, and FIG. 3 shows the percentage of data volume saved when a facet is filtered by average value. This percentage is calculated as 100×(O−F)/O, where O is the amount of data transferred for the default facet and F is the amount of data transferred for the filtered facet. In FIGS. 2 and 3, it can be clearly seen that the method of facet-based searching of databases, using both extreme value and average value filtering, saves data volume transferred between the database and the client.

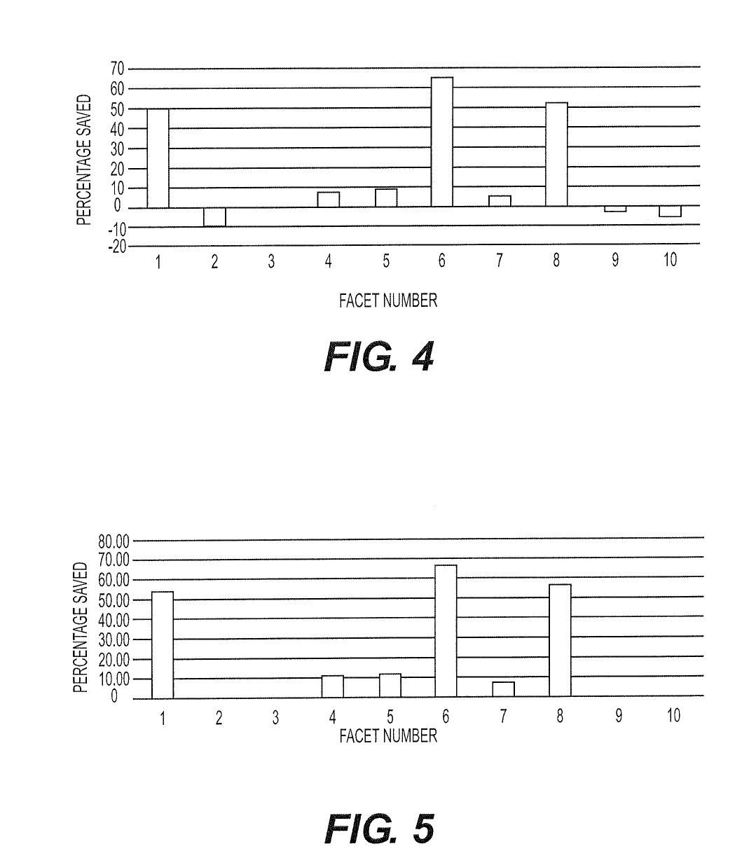

FIGS. 4 and 5 each show the percentage of data saved by significance filtering when compared against facet generation filtered by frequency. FIG. 4 shows that there is sometimes a gain in the data sent from the server (i.e., the entries with negative value). This is due to the fact that the significance score displayed with the facet values adds five digits to each facet value and, in some cases, this results in generating more data when compared to the default facet value display. FIG. 5 shows a fairer comparison, where the percentage of data saved is calculated by setting O to be the amount of data sent when the default facet is generated by replacing the frequency count with the significance score.

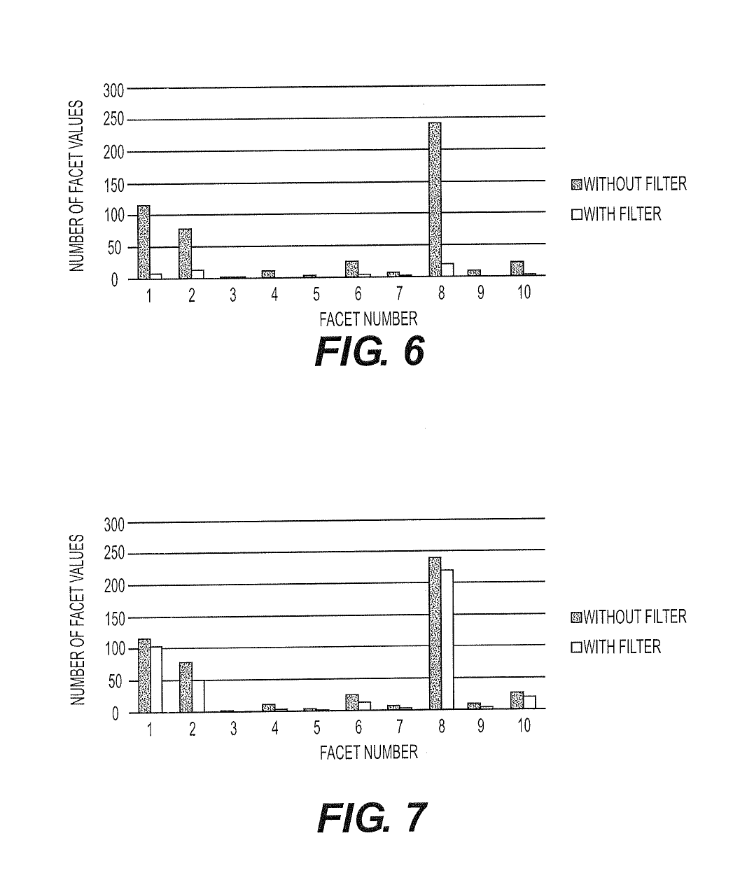

FIGS. 6, 7 and 8 compare the number of facet values produced using extreme value filtering, average value filtering and significance filtering, respectively, each compared against the control case; i.e., results produced with no filtering. One can see in FIGS. 6, 7 and 8 that the number of options may reduce significantly when filtering is applied. This is particularly noticeable for the extreme value filtering. The average value filtering has cutoffs set at the second and third quartiles of the frequency distribution in the search settings, which may be considered to be a very lenient filter. A narrower range would produce a smaller set of facet values closer to the average.

A comparison of time complexity was also performed. The time taken for generating a facet has two components: the first component is the time taken to generate the facets, and the second component is the time taken to transfer the data from the server to the user. For the default facet generation, the time is given by O(n·log n)+o(n), where n is the number of facet values. The first term in this expression is for ranking the facet values by sorting them by rank, and the second term is the time taken to transfer the data. This complexity applies for facet generation method that use any form of ranking, where an additional term (n) maybe added for calculating the ranks of facet values. When the method of facet-based searching of databases is applied, the time complexity is O(n·log n)+o(occ), where occ is the number of facet values passing the filter, and occ≤n. Thus, the method of facet-based searching of databases has a smaller time complexity.

If a set covering method is used for facets, only an approximation solution can be found since set covering is an NP-complete problem. Therefore, the complexity for approximate set covering is estimated using a greedy method. The method requires access to the solution space of the query, and if the solution space is R, then this takes a time of o(|R|), where it should be noted that R should at least consist of faceted features of the solution space. If there are K facets, a time of K log K is taken to sort the facets by the number of search results they have. The set covering is then performed by greedily checking which facets will completely cover the search space or until some fixed number of facets k has been analyzed.

For efficiently checking if an element in a facet has already been covered, a linear search will be time consuming. A binary search would take a time of O(|R| log(|R|)) to prepare the search space, and O(log(|R|)) to check covering. If it is assumed that K<<R, then the time complexity is O(|R| log(|R|)). For the present facet ranking method, the time complexity is given as Σᵢ₌₁^{K}|Fᵢ|·log(|Fᵢ|), where Fᵢ is a facet, as this only involves one sorting operation of facet values. Unless K=1 and F₁=R, then Σᵢ₌₁^{K}|Fᵢ|·log(|Fᵢ|)<(Σᵢ₌₁^{K}|Fᵢ|)·log(Σᵢ₌₁^{K}Fᵢ)<|R| log(|R|). It is unlikely that the exceptional case where a single facet value contains all the values occurs and, in practice, Σᵢ₌₁^{K}|Fᵢ|<<|R|; i.e., the total number of facet values is much smaller than the total search space. For methods involving decision trees, the whole search space again needs to be accessed. The time taken to build the decision tree would be O(|R| log(|R|)). It can be sees that unless there is a single facet encompassing the whole search space, then the method of facet-based searching of databases takes less time. It should also be noted that in the case where F₁=R, no further processing needs to be performed and the facet can be shown immediately.

For purposes evaluating the effectiveness of the above facet ranking method, a database of HBV integration sites into a genome, taken from a publication, was used. The goal of the publication was to find genes that are affected by HBV integration, and four genes were identified. By setting the number of maximum facet values that can be handled by a user to 15 (i.e., V=15), the following ordering of facets is obtained:

TABLE 1
Facet Ranking for V = 15

| Facet | Score |
|---|---|
| Genes involved in integration | 7.00 |
| Sample | 12.77 |
| Major repeat | 28.57 |
| Chromosome | 39.00 |
| HBV genes | 41.13 |
| Minor repeat | 49.50 |
| Nearest gene context | 57.00 |
| Genetic context | 70.33 |
| Gene orientation | 157.60 |
| Tissue type | 199.50 |

There are 11 facet values with a score assigned, and eight more without a score due to their exceeding the facet value count. The top facet contains all four important genes found in the study. There were other possible facets, such as genome location, distance to repeats and human/viral integration, that generated hundreds of facet values and had an infinite score. They would not be useful to the user unless he or she has knowledge about specific values in them or further filtering has reduced the facet values in them.

There were several other facets without a finite score that did contain important information regarding the four genes. Setting a looser criteria of V=20 resulted in the following list of facets:

TABLE 2
Facet Ranking for V = 20

| Facet | Score |
|---|---|
| Nearest Refseq gene to | 6.28 |
| integration | |
| Nearest gene to integration | 6.28 |
| Nearest ensemble gene | 6.19 |
| Gene involved in integration | 7.00 |
| Sample | 12.77 |
| Minor repeat | 49.50 |
| Chromosome | 39.00 |
| Major repeat | 28.57 |
| HBV genes | 41.13 |
| Nearest gene context | 57.00 |
| Genetic context | 70.33 |
| Gene orientation | 157.60 |
| Tissue type | 199.50 |

In Table 2, the list of genes important to viral integration appears as facet values in the top four facets. In contrast to the first list of facets given in Table 1, the facets with genes that are close to an integration appear, which increases the facet size. Even in this list, unimportant facets, such as genome location, do not appear. This example shows that the method of facet-based searching of databases is useful when a user has a large choice of facets.

It is to be understood that the method of facet-based searching of databases is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A method of facet-based searching of databases, comprising the steps of:
receiving search results;
adding a context dependent facet set to the search results, wherein the context dependent facet set includes a facet value for each of a plurality of facets associated with the search results, and a facet value count, wherein the facet value count is a count of the search results to which the facet value applies;
displaying to the user a list of the facets and the facet value counts, wherein the list of the facets and the facet value counts is ordered according to a selected ranking of facets;
receiving a selection of at least one facet from the list of the facets and the facet value counts from the user;
filtering the search results based on the selection of the at least one facet; and
displaying at least a subset of the filtered search results to the user, wherein the subset of the filtered search results is based on a user-selected parameter.

2. The method of facet-based searching of databases as recited in claim 1, wherein the user-selected parameter is a frequency of the facet values in the search results.

3. The method of facet-based searching of databases as recited in claim 2, wherein the step of displaying at least a subset of the filtered search results to the user comprises displaying search results to the user found within a selected range of average frequency values.

4. The method of facet-based searching of databases as recited in claim 2, wherein the step of displaying at least a subset of the filtered search results to the user comprises displaying search results to the user found within a selected range of most common frequency values.

5. The method of facet-based searching of databases as recited in claim 2, wherein the step of displaying at least a subset of the filtered search results to the user comprises displaying search results to the user found within a selected range of least common frequency values.

6. The method of facet-based searching of databases as recited in claim 1, wherein the user-selected parameter is a significance score based on a probability of the facet values in the search results not appearing by chance.

7. The method of facet-based searching of databases as recited in claim 6, wherein the step of displaying at least a subset of the filtered search results to the user comprises displaying search results to the user found within a selected range of greatest significance scores.

8. The method of facet-based searching of databases as recited in claim 6, wherein the step of displaying at least a subset of the filtered search results to the user comprises displaying search results to the user found within a selected range of least significance scores.

9. A computer software product that includes a non-transitory storage medium readable by a processor, the non-transitory storage medium having stored thereon a set of instructions for performing facet-based searching of databases, the instructions comprising:
(a) a first set of instructions which, when loaded into main memory and executed by the processor, causes the processor to receive search results;
(b) a second set of instructions which, when loaded into main memory and executed by the processor, causes the processor to add a context dependent facet set to the search results, wherein the context dependent facet set includes a facet value for each of a plurality of facets associated with the search results, and a facet value count, wherein the facet value count is a count of the search results to which the facet value applies;
(c) a third set of instructions which, when loaded into main memory and executed by the processor, causes the processor to display to the user a list of the facets and the facet value counts, wherein the list of the facets and the facet value counts is ordered according to a selected ranking of facets;
(d) a fourth set of instructions which, when loaded into main memory and executed by the processor, causes the processor to receive a selection of at least one facet from the list of the facets and the facet value counts from the user;
(e) a fifth set of instructions which, when loaded into main memory and executed by the processor, causes the processor to filter the search results based on the selection of the at least one facet; and
(f) a sixth set of instructions which, when loaded into main memory and executed by the processor, causes the processor to display at least a subset of the filtered search results to the user, wherein the subset of the filtered search results is based on a user-selected parameter.

10. The computer software product as recited in claim 9, wherein the user-selected parameter of the sixth set of instructions comprises a frequency of the facet values in the search results.

11. The computer software product as recited in claim 10, wherein the sixth set of instructions comprises displaying search results to the user found within a selected range of average frequency values.

12. The computer software product as recited in claim 10, wherein the sixth set of instructions comprises displaying search results to the user found within a selected range of most common frequency values.

13. The computer software product as recited in claim 10, wherein the sixth set of instructions comprises displaying search results to the user found within a selected range of least common frequency values.

14. The computer software product as recited in claim 9, wherein the user-selected parameter of the sixth set of instructions comprises a significance score based on a probability of the facet values in the search results not appearing by chance.

15. The computer software product as recited in claim 14, wherein the sixth set of instructions comprises displaying search results to the user found within a selected range of greatest significance scores.

16. The computer software product as recited in claim 14, wherein the sixth set of instructions comprises displaying search results to the user found within a selected range of least significance scores.
